(19) United States
(12) Patent Application Publication
(10) Pub. No.: US 2021/0377615 A1
(43) Pub. Date: Dec. 2, 2021

(54) SYSTEM AND METHOD FOR SIMULATING A LIVE AUDIENCE AT SPORTING EVENTS

(71) Applicants: Timothy DeWitt, Annapolis, MD (US); Christian Madsen, Annapolis, MD (US)

(72) Inventors: Timothy DeWitt, Annapolis, MD (US); Christian Madsen, Annapolis, MD (US)

(21) Appl. No.: 17/136,476

(22) Filed: Dec. 29, 2020

Related U.S. Application Data
(60) Provisional application No. 63/039,424, filed on Jun. 15, 2020.
(60) Provisional application No. 63/034,502, filed on Jun. 4, 2020.
(60) Provisional application No. 63/033,183, filed on Jun. 1, 2020.

(51) Int. Cl. H04N 21/4788; H04N 21/2187

(52) U.S. Cl. CPC H04N 21/4788; H04N 21/2187

(57) ABSTRACT

A system and method that collects fan response data through feedback from fan devices (mobile phones, tablets, computers, televisions, etc.), processes and/or compiles the feedback data, and produces audio at a venue and/or broadcasts the produced audio together with video of the event taking place at the venue.

### CROSS-REFERENCE TO RELATED APPLICATIONS

The present application claims the benefit of the filing date of U.S. Provisional Patent Application Ser. No. 63/039,424 filed by the present inventors on Jun. 15, 2020, U.S. Provisional Patent Application Ser. No. 63/034,502 filed by the present inventors on Jun. 4, 2020 U.S. Provisional Patent Application Ser. No. 63/033,183 filed by the present inventors on Jun. 1, 2020.

The aforementioned provisional patent applications are hereby incorporated by reference in their entirety.

### STATEMENT REGARDING FEDERALLY SPONSORED RESEARCH OR DEVELOPMENT

None.

### BACKGROUND OF THE INVENTION

### Field of the Invention

The present invention relates to systems and methods for broadcasting (or streaming) and viewing sporting events.

### Brief Description of the Related Art

Viewing events remotely on television is a very different experience that viewing such an event in person. The recent pandemic has brought this distinction to a new level with fanless sporting events where few or no fans attend an event in person such that nearly all fans watch the event on some type of video and audio feed. Such fanless event create a quiet and sterile environment not only for players and coaches but also for the viewing audience. Fans are unable to inspire their teams or assist their teams through cheering.

Heretofore, various systems have proposed systems and methods for improving the viewing experience of remote fans. Such systems and methods, however, assume a “live environment” at the event and attempt to provide remote fans with access to viewing or experiencing that “live environment remotely. For example, U.S. Published Patent Application No. 2018/0376207 proposed a system and method for technological facilitation of virtual in-venue experience for remove spectator(s) of an event. The method includes receiving one or more sets of audio-visual feeds of the event. A set of audio-visual feeds of the one or more sets of audio-visual feeds includes a primary audio-visual feed and one or more secondary audio-visual feeds. The primary audio-visual feed of the set includes main audio-visual content for that set and the secondary audio-visual feed(s) includes secondary audio-visual content of the event, supplemental to the main audio-visual content, from a respective location within a venue hosting the event and including peripheral field of view audio visual content supplemental for that set. Each set of audio-visual feed is captured, at least in part, from a different respective location within the venue. The method further includes displaying the primary audio-visual feed of the set of audio-visual feeds for viewing by a remote spectator, and also displaying in association therewith, at least in part, the secondary audio-visual feed(s) of the set in the peripheral field of view of the remote spectator. The secondary audio-visual feed(s) provides the remote spectator with peripheral audio content at the respective location supplemental to the main audio-visual content, thereby facilitating the in-venue experience for the remote spectator

### SUMMARY OF THE INVENTION

A system and method that collects fan response data through feedback from fan devices (mobile phones, tablets, computers, televisions, etc.), processes and/or compiles the feedback data, and produces audio at a venue and/or broadcasts the produced audio together with video of the event taking place at the venue.

The present invention satisfies a variety of needs. Fanless sporting events result in a sterile television experience that lacks the excitement of traditional live events. Simulating the environment of a traditional live event will improve the televised experience by adding the effects of fan responses to the action Broadcasting live fan response data in the venue will produce a more exciting event, inspire participants in the event, and allow fan to influence the action as they do in a traditional live sporting event. Makes playing sporting events at “seatless venue” possible (made for television broadcast sporting events)

Pay-per-view event could provide video/audio experience from a virtual seat location in a venue. Front row virtual seat receives/plays different audio and/or video stream than nosebleed seat. Allows for remote viewing to simulate specific seat locations. In addition to fans physically present at the sporting event, allowing remote fans to participate in the event in a similar way to those physically present.

In a preferred embodiment, the present invention is a method for simulating a live event audience. The method comprises the steps of registering a plurality of local devices for remote participation in a live event, associating with each registered local device one of a plurality of locations in a live event venue, collecting feedback data at a plurality of the registered local devices, sending the collected feedback data from the registered local device to a server, processing received collected feedback data with the server to produce a multi-channel feedback audio stream, wherein the multi-channel audio stream comprises at least a first channel representative of feedback data from registered devices associated with a first location in the live event venue and a second channel presentative of feedback data from a second location in the live vent venue, and streaming the multi-channel feedback audio stream over a live event venue audio system with the first channel being broadcast from one or more speakers at the first location in the live event venue and the second channel being broadcast from one or more speakers at the second location in the live event venue, wherein the second location is different from the first location.

The step of associating with each registered local device one of a plurality of locations in a live event venue may comprises associating a first plurality of registered local devices with the first location in the live event venue based upon geographic locations of the registered local devices, such as through GPS data of the registered local devices. The step of associating with each registered local device one of a plurality of locations in a live event venue may further comprise associating a second plurality of registered local devices with the second location in the live event venue based upon geographic locations of the registered local devices. In other embodiments, the step of associating with each registered local device one of a plurality of locations in a live event venue may comprise associating a first plurality of registered local devices with a first location in the live event venue based upon user selections or user data.

The step of collecting feedback data may comprises recording audio with the local devices or detecting variations in sound levels with the local devices. The detecting variations in sound levels may comprise detecting with each local device a difference between an ambient sound level and a current sound level. The ambient sound level may comprise a mean sound level over a pre-determined period of time. The ambient sound level may be continuously recalculated using an immediately preceding period of time. The feedback data may comprise audio recordings. The multi-channel feedback audio stream may comprise pre-recorded audio adjusted to reflect the collected feedback data.

In another preferred embodiment, the present invention comprises a method for simulating a live event audience. The method comprises registering a plurality of local devices for remote participation in a live event, associating with each registered local device one of a plurality of locations in a live event venue, collecting audio feedback data at a plurality of the registered local devices, transmitting the collected audio feedback data from the registered local device to a cloud server, receiving and processing received collected audio feedback data with the cloud server to produce a multi-channel feedback audio stream, wherein the multi-channel audio stream comprises at least a first channel representative of feedback data from registered devices associated with a first location in the live event venue and a second channel presentative of feedback data from a second location in the live vent venue, transmitting the multi-channel audio signal to a venue server, and streaming the multi-channel feedback audio stream over a live event venue audio system with the first channel being broadcast from one or more speakers at the first location in the live event venue and the second channel being broadcast from one or more speakers at the second location in the live event venue.

The step of associating with each registered local device one of a plurality of locations in a live event venue comprises associating a plurality of registered local devices with a location in the live event venue based upon geographic locations of the plurality of registered local devices. The step of collecting audio feedback data may comprise recording audio with the registered local devices. The step of collecting audio feedback may comprise recording audio with a registered local device only when a sound level detected by the registered local device exceeds a threshold sound level. The threshold sound level may comprise a calculated ambient sound level at the registered local device.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature and not as restrictive. Additional objects and advantages of the invention will be set forth in part in the description which follows and in part will be obvious from the description or may be learned by practice of the invention.

### BRIEF DESCRIPTION OF THE DRAWINGS

For a more complete understanding of the present invention and the advantages thereof, reference is now made to the following description and the accompanying drawings, in which:

FIG. 1 a diagram illustrating a method in accordance with a preferred embodiment of the present invention.

FIG. 2 is a diagram illustrating a system architecture and flow for a single venue in accordance with a preferred embodiment of the present invention.

FIG. 3 is a diagram illustrating a system architecture and flow for a multi-venue in accordance with a preferred embodiment of the present invention.

### DETAILED DESCRIPTION OF THE PREFERRED EMBODIMENTS

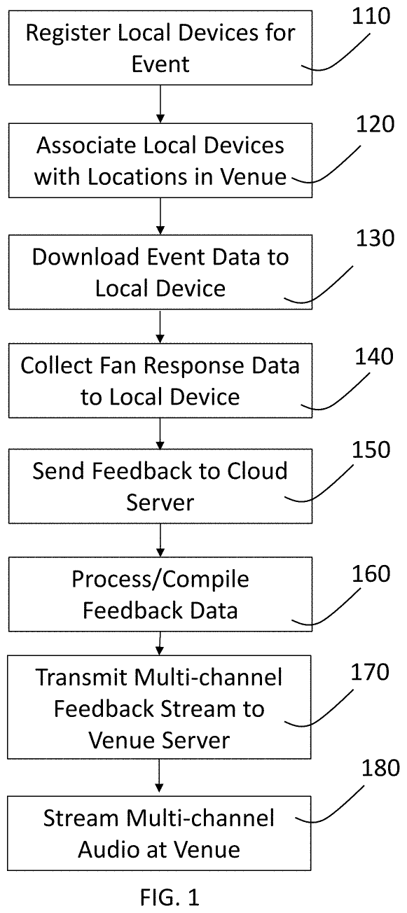

A general system flow in accordance with a preferred embodiment of the present invention is described with reference to FIG. 1. A fan experience application is downloaded to a user device or the fan experience website is brought up on a browser on the user device. The user device (a “local device”) may be any computing device, including but not limited to a mobile phone, a tablet computer, a laptop computer, a desktop computer, a smart TV or even a smart watch or other device. The application provides users with ability to register their local device for a particular live event 110. The registration may require input of user, device or location data or automatic retrieval of data previously entered or detected (such as GPS data) from the user's local device. The application may register users through a listing or guide, through prompts, or through any other means such as scanning a code displayed on a television screen or other display. The system also may be accessed by fans through a website rather than through an application. The user's device is associated with a particular location in the live event venue 120. A location within a live event venue, for example, may be a particular seating section in the venue (e.g., “south stands,” “home stands,” or “visitor stands”) or may be something more specific such as a particular seat within the venue. When a user registers for an event, event data or code may be downloaded to the user device 130. Such a download may allow for processing and/or compression to be performed on the user device. Once the user registers the application can activate the microphone, video or other input means from the user's device to collect feedback data. The feedback data may include audio, video, typed data such as “chat” messages, pre-set responses (e.g., cheer, boo, groan). The local device collects, processes and/or compresses feedback 140 at the local device into feedback data that is transmitted from the local device to a cloud server, via any known means such as Wi-Fi or cell service 150. The cloud server processes and/or compiles the feedback data to generate a multi-channel feedback audio stream and/or a video stream 160. That multi-channel feedback audio and/or video stream is then transmitted to venue server 170 that can play the feedback stream at the venue, for example, over a stadium audio system or shown on a scoreboard 180. Alternatively, the feedback stream can be played over an event broadcast or stream without being played over the venue audio or video system.

The feedback collected at the local device can take any number of forms. For example, it could take the form of actual sound recordings or filtered sounds recordings that, for example, filter out ambient sound. In another embodiment that could require transmission of less data and provide user privacy, the local device could measure sound levels. The ambient sound level can be measured prior to the start of the event and updated during the event and then that ambient sound level (or, for example, an average thereof) can be used to detect changes (including peaks or valleys) in sound levels that reflect different types of fan reactions (excitement, shock, chanting, etc.). The detected changes can then be transmitted as feedback data. In still other embodiments, the microphone on the local device can be activated only when the sound level exceeds a threshold level, which could be fixed or could be a detected ambient sound level, such that sound is recorded and transmitted only during cheering, clapping or other reactions to the live event action.

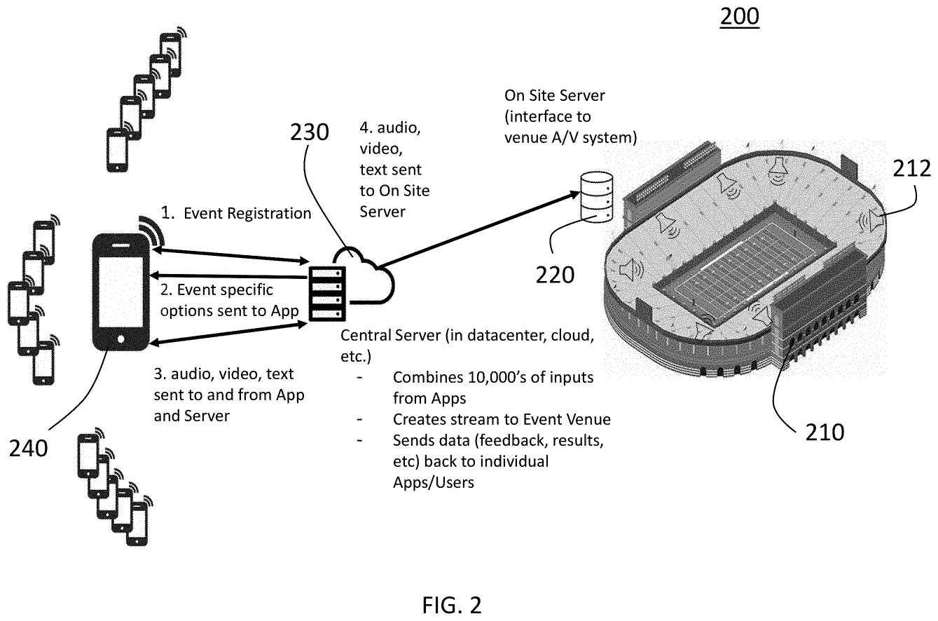

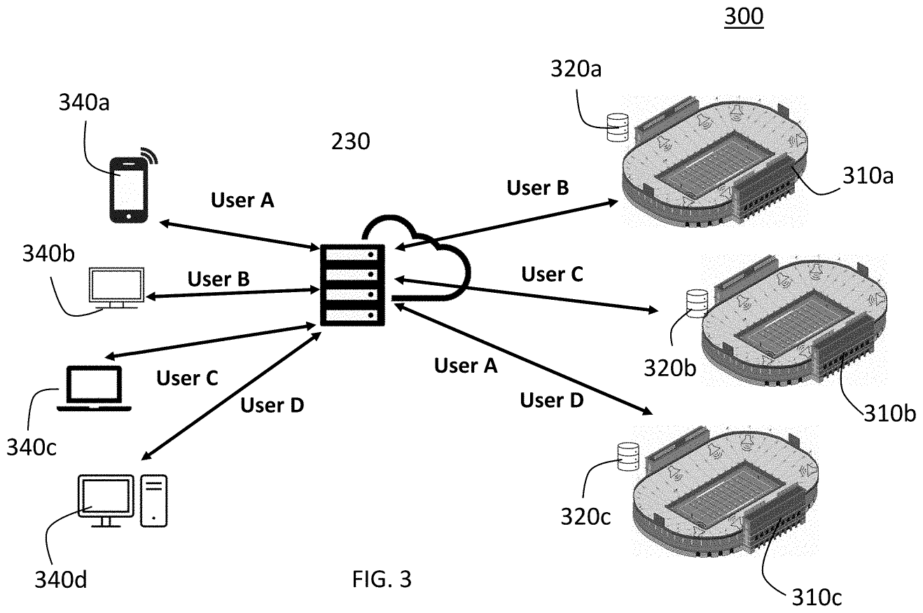

FIG. 2 illustrates the architecture and flow with respect to a single venue in accordance with a preferred embodiment of the present invention. FIG. 3 illustrates an architecture and flow with respect to multiple venues in accordance with a preferred embodiment of the present invention.

### Fan Experience App

The App should have the capability to run on any video capable device such as mobile phones, tablets, laptops, PC's, television. Also available via a website.

App can be downloaded to device or can be pre-loaded on device.

Update App automatically.

Rather than being a standalone App, the App functionality can be incorporated into an existing App.

### Fan Registration

Users/Fans register for specific events through the App.

Registration can include/require any information that would be useful in providing an optimum fan experience.

Fan registration can include a fee.

Fees can be varied to reflect any parameter such as virtual seat location, premium (added weight) feedback.

Fees can also be paid for by teams, or included via virtual tickets.

Fan registration can include information to categorize fans: Home/Away Fan, Student, Alum, Heckler.

### Fan Feedback

Fan Feedback can encompass a wide variety of types of feedback: audio, video, text, or other input (such as pressing buttons that appear on the user device).

Audio Feedback: Can include filter, for example, to limit feedback to cheering or to block feedback of background chatter; pre-defined reactions (e.g., cheers, boos).

User on/off selection of feedback (mute video/audio).

### Sending Feedback to Cloud Server

Processing can occur on mobile device to compress, compile, select or manipulate data to send to cloud server.

Data can include markers to identify the event associated with the data, the user registration category, or other information.

### Processing/Compiling Fan Feedback Stream

Received fan feedback data can be processed at the cloud server to create a multi-channel fan experience audio stream. The processing can include groupings similar categories of sound or weighting feedback based on any of a variety of factors such as providing greater weight to devices that have been registered for live events featuring a particular team previously or based upon the location of the local device, e.g., devices closer to the venue receive greater weight as representing home fans.

Audio stream includes multiple channels to play different categories of feedback from different locations in a stadium to create various effects (like a student section with louder audio output than other sections, or a visitor's section with different audio output than other sections). It also is possible to send the composite feedback audio stream to a user's local device to be combined with the live video stream. With such an embodiment, a user's local surround sound system could be used to create a stadium-like effect by playing such that it is virtually associated with different locations in the stadium:
Could include video to be displayed on Scoreboard at venue;
Could include “video seat” streams. Limited number of video devices, for example, placed behind a team bench or seat, that have 2-way video so the fan appears on the video monitor in the “video seat” and the fan can see the video captured by that specific video device; and
Could include “heckler seats,” streams for example, that play a specific fan audio feed from a specific seat location in the stands.

### Playing Fan Feedback Stream

Fan feedback audio stream can be played at venue and/or over television/livestream broadcast. The feedback stream could include “video seats” that have specific monitors at the live event venue. A limited number of video devices, for example, placed behind a team bench or seat, that have 2-way video so the fan appears on the video monitor in the “video seat” and the fan can see the video captured by that specific video device. Another example could include “heckler seats,” for example, that play a specific fan audio feed from a specific seat location in the stands such as behind the visiting team's bench.

The feedback stream further may include video to display on a scoreboard at venue or to display on over a broadcast/livestream,

Each User can select from either a list of current events or set a reminder for future events.

The central Server than establishes a connection between the user and the selected event, via the on-site server which has access to the local audio and video system.

### Internal Stadium Hookup

The Central Server and the On-Site Server are connected via standard HTTPS connections via widely available Internet.

The On-Site Server is housed alongside existing Audio Video (A/V) equipment at the venue.

Standard audio/video connections can be made through any combination of HDMI (audio and/or video), Optical Audio connections and Bluetooth connections.

Multiple connections from the Local Server to the Stadium systems can also be handled to allow for multiple A/V services.

### Phone/Webpage Interface

A list of currently available events the user can join.

A calendar of future events the user can reserve and schedule.

An audio button allowing for the sending of audio input to the event (through the Central Server).

A list of event specific audio ‘reactions’ to send to event.

A real-time stream of other active users (event participant) text reactions, and comments, during the event.

Displayed data may include, for example, the following:
Total users participating in the event (in the case of sporting events, both ‘home’ and ‘visitor’ users); and
A series of graphics showing audio reaction sentiments (positive, negative, audio level, etc.).

### Sound Compression/Compilation

Sound is initially compressed, and categorized when possible on the user's device.

The Centralized Server processes each user stream into a single unified stream, which is then sent to the On-Site Server at the Stadiums and/or venues based on which event the user has signed up for.

The On-Site Server receives the sound, along with tags, and sends the signal to the local audio equipment.

If the local audio equipment has multiple zones (such as sections within the stadium) differing audio volume is sent to each zone signify based on tags. (positive/negative) and or virtual location (for example, home section vs away section)

### Scoreboard Display of Real-time Data

A real-time scoreboard display may include, for example, the following:
A graphic showing the total active users;
A graphic showing both Home and Away/Visitor users (for sporting events); and
A series of graphics summarizing the audience sentiment, including:
   Positive/Negative for overall users;
   Positive/Negative for both Home and Away users; and
   Summary of the number of users who have chosen.

### Audio Overlay Embodiment

Many applications and websites are available that allow livestreaming of events through a local device. Such livestreaming commonly includes video of the event and audio that is either live audio from the event, a commentary that could be produced at the event or at a location remote from the event, or a combination of live audio and a commentary. Some examples also may exist in which a recorded soundtrack of some type is played with the live video on the livestream. Additional examples exist of running text or chat messages received from viewers of the livestream being displayed with video of the event.

In an alternative embodiment of the present invention, feedback audio data is collected from viewers by a local device such as a device through which they are watching the livestream or a separate device such as an Alexa device or Siri on an iPhone. The local audio data is transmitted to a server or is processed locally to generate audio feedback data and the audio feedback data is transmitted back to the server. The server compiles the received audio feedback data to generate a composite audio stream to transmit to the local devices that is overlaid with or played with the streaming video. The composite feedback audio stream also could include a commentary from the venue of the live event or from a studio combined with the composite feedback audio feedback stream to produce on the local device an experience similar to that of watching a live event on television.

While this can be used with fanless or empty stadium events, it also could be used in other situations. For example, during large sporting events such as baseball's World Series fans of an away team often gather for watch parties, for example, in the local stadium where there is no ongoing live event or at another gathering location. Fans often attend these watch parties to experience the feel of a home stadium filled with fans even if the event is taking place elsewhere and is simply being shown on a large screen at the watch party location. With the present invention, it is possible to create a variety of “live” audio streams that can be played with or overlayed on a video livestream. For example, the local device can use an internal global positioning system to determine the location of the device and based on that location categorize audio feedback from that particular device as “home fan feedback,” “away fan feedback” or “neutral feedback. Depending on the user's location, the user could automatically hear with the livestream of the event video a feedback audio stream associated with their geographic location. Another possibility with the present invention is that user could select which audio feed to receive or which audio feed to contribute to. Still further, the system could allow for or require registration of users during which users can select favorite teams, conferences, cities or countries such that they would hear feedback audio streams associated with preferences and also could contribute to the feedback for their favorite teams or athlete.

Still further, the present invention could be used in the context of non-sport event such as a musical performance. Using as an example a Facebook live musical performance, the performer performs music in front of their local device and receives feedback via a stream of chat messages. Those chat messages also can be viewed by others watching the Facebook live performance. With the present invention, audio feedback can be received from views of the live performance and can be overlayed with the performance so a composite feedback audio is heard with the performance, or and composite feedback audio can be played on the performers local device separate from the performer's music so the performer can hear the composite audio feedback from viewers.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto and their equivalents. The entirety of each of the aforementioned documents is incorporated by reference herein.

What is claimed is:

1. A method for simulating a live event audience comprising:
registering a plurality of local devices for remote participation in a live event;
associating with each registered local device one of a plurality of locations in a live event venue;
collecting feedback data at a plurality of said registered local devices;
sending the collected feedback data from the registered local device to a server;
processing received collected feedback data with said server to produce a multi-channel feedback audio stream, wherein said multi-channel audio stream comprises at least a first channel representative of feedback data from registered devices associated with a first location in said live event venue and a second channel presentative of feedback data from a second location in said live vent venue; and
streaming said multi-channel feedback audio stream over a live event venue audio system with said first channel being broadcast from one or more speakers at said first location in said live event venue and said second channel being broadcast from one or more speakers at said second location in said live event venue, wherein said second location is different from said first location.

2. A method for simulating a live event audience according to claim 1, wherein said step of associating with each registered local device one of a plurality of locations in a live event venue comprises associating a first plurality of registered local devices with said first location in said live event venue based upon geographic locations of said registered local devices.

3. A method for simulating a live event audience according to claim 2, wherein said step of associating with each registered local device one of a plurality of locations in a live event venue further comprises associating a second plurality of registered local devices with said second location in said live event venue based upon geographic locations of said registered local devices.

4. A method for simulating a live event audience according to claim 1, wherein said step of associating with each registered local device one of a plurality of locations in a live event venue comprises associating a first plurality of registered local devices with a first location in said live event venue based upon user selections.

5. The method for simulating a live event audience according to claim 1, wherein said collecting feedback data comprises recording audio with said local devices.

6. The method for simulating a live event audience according to claim 1, wherein said collecting feedback data comprises detecting variations in sound levels with said local devices.

7. The method for simulating a live event audience according to claim 6, wherein said detecting variations in sound levels comprises detecting with each local device a difference between an ambient sound level and a current sound level.

8. The method for simulating a live event audience according to claim 7, wherein said ambient sound level comprises a mean sound level over a pre-determined period of time.

9. The method for simulating a live event audience according to claim 7, wherein said ambient sound level is continuously recalculated using an immediately preceding period of time.

10. A method for simulating a live event audience according to claim 1, wherein said feedback data comprises audio recordings.

11. A method for simulating a live event audience according to claim 1, wherein said multi-channel feedback audio stream comprises pre-recorded audio adjusted to reflect said collected feedback data.

12. A method for simulating a live event audience comprising:
registering a plurality of local devices for remote participation in a live event;
associating with each registered local device one of a plurality of locations in a live event venue;
collecting audio feedback data at a plurality of said registered local devices;
transmitting the collected audio feedback data from the registered local device to a cloud server;
receiving and processing received collected audio feedback data with said cloud server to produce a multi-channel feedback audio stream, wherein said multi-channel audio stream comprises at least a first channel representative of feedback data from registered devices associated with a first location in said live event venue and a second channel presentative of feedback data from a second location in said live vent venue;
transmitting said multi-channel audio signal to a venue server; and
streaming said multi-channel feedback audio stream over a live event venue audio system with said first channel being broadcast from one or more speakers at said first location in said live event venue and said second channel being broadcast from one or more speakers at said second location in said live event venue.

13. A method for simulating a live event audience according to claim 12, wherein said step of associating with each registered local device one of a plurality of locations in a live event venue comprises associating a plurality of registered local devices with a location in said live event venue based upon geographic locations of said plurality of registered local devices.

14. The method for simulating a live event audience according to claim 12, wherein said collecting audio feedback data comprises recording audio with said registered local devices.

15. The method for simulating a live event audience according to claim 12, wherein said collecting feedback data comprises detecting variations in sound levels with said local device.

16. The method for simulating a live event audience according to claim 15, wherein said detecting variations in sound levels comprises detecting a difference between an ambient sound level and a current sound level.

17. The method for simulating a live event audience according to claim 16, wherein said ambient sound level comprises a mean sound level over a pre-determined period of time.

18. The method for simulating a live event audience according to claim 16, wherein said ambient sound level is continuously recalculated using an immediately preceding period of time.

19. A method for simulating a live event audience according to claim 12, wherein said step of collecting audio feedback comprises:
recording audio with a registered local device only when a sound level detected by said registered local device exceeds a threshold sound level.

20. A method for simulating a live event audience according to claim 19, wherein said threshold sound level comprises a calculated ambient sound level at said registered local device.
